(19) United States
(12) Patent Application Publication
(10) Pub. No.: US 2019/0077041 A1
(43) Pub. Date: Mar. 14, 2019

(54) TREATED POROUS MATERIAL

(71) Applicant: DOW GLOBAL TECHNOLOGIES LLC, Midland, MI (US)

(72) Inventors: Xue Chen, Manvel, TX (US); Stephen W. King, League City, TX (US); David L. Malotky, Midland, MI (US)

(21) Appl. No.: 15/771,537

(22) PCT Filed: Oct. 26, 2016
(86) PCT No.: PCT/US2016/058744

§ 371 Date: Apr. 27, 2018

Related U.S. Application Data
(60) Provisional application No. 62/246,940, filed on Oct. 27, 2015.

(51) Int. Cl. B27K 3/15; C08H 8/00; C08G 63/688

(52) U.S. Cl. CPC B27K 3/153; C08H 8/00; B27K 2200/10; B27K 2240/70; C08G 63/6884

(57) ABSTRACT

A treated cellulosic material comprising a cellulosic material having a porous structure defining a plurality of pores, at least a portion of the pores containing a treating agent comprising a polymer comprising a sulfopolyester polymer. The present disclosure further describes a method for preparing a treated cellulosic material comprising (a) providing a cellulosic material; and (b) a first treatment protocol comprising impregnating the cellulosic material with an aqueous dispersion comprising a polymer, the polymer comprising a sulfopolyester polymer.

### BACKGROUND OF THE INVENTION

Porous materials, such as cellulosic materials, need to be protected from mold growth, insect attack, rot and water impregnation to help preserve the physical properties of the cellulosic material. One example of such a cellulosic material is wood. A variety of treatment agents and preservation methods are known to preserve cellulosic materials.

Modern preservation methods typically involve pressure treating the cellulosic material with a treating agent. Pressure treatment typically allows the treating agent to penetrate throughout the porous structure of the cellulosic material. The treating agent is typically a chemical compound selected to impart the desired physical properties to the cellulosic material. For example, treating agents that add water resistance and improve the dimensional stability of the cellulosic material are of interest. Wood is capable of absorbing as much as 100% of its weight in water which causes the wood to swell, which, after loss of water through evaporation causes the wood to shrink. This process of water absorption/evaporation is non-uniform and creates internal stresses in the wood leading to splitting, warping, bowing, crooking, twisting, cupping, etc. Also, water can serve as a pathway for organisms that degrade the cellulosic material, such as insects or fungus. Treating agents that repel insects, or minimize the formation of fungi/molds, or improve the overall durability of the cellulosic material are of interest. Further, treating agents can improve wind resistance, ultraviolet radiation resistance, stability at high and low temperatures, pest resistance, mold resistance, fire resistance and other issues which might affect the physical properties of the cellulosic material.

An improved treating agent for cellulosic materials is desired.

### SUMMARY OF THE INVENTION

The present disclosure describes a treated cellulosic material comprising a cellulosic material having a porous structure defining a plurality of pores, at least a portion of the pores containing a treating agent comprising a polymer comprising a sulfopolyester polymer.

The present disclosure further describes a method for preparing a treated cellulosic material comprising (a) providing a cellulosic material; and (b) a first treatment protocol comprising impregnating the cellulosic material with an aqueous dispersion comprising a polymer, the polymer comprising a sulfopolyester polymer.

### DETAILED DESCRIPTION OF THE INVENTION

As used herein, the term “porous material” refers to a material which is permeable such that fluids are movable therethrough by way of pores or other passages. An example of a porous material is a cellulosic material. Other examples of porous materials include stone, concrete, ceramics, and derivatives thereof. As used herein, the term “cellulosic material” refers to a material that includes cellulose as a structural component. Examples of cellulosic materials include wood, paper, textiles, rope, particleboard and other biologic and synthetic materials. As used herein, wood includes solid wood and all wood composite materials (e.g., chipboard, engineered wood products, etc.). Cellulosic materials generally have a porous structure that defines a plurality of pores.

A “treated cellulosic material” is a cellulosic material that has been treated with a treating agent to modify the properties of the cellulosic material. The properties modified by the treating agent include, but are not limited to, increased hydrophobicity, dimensional stability, fungi resistance, mold resistance, insect resistance, hardness, surface appearance, UV stability, fire resistance, and coatability. Increasing the hydrophobicity of a cellulosic material can provide other ancillary benefits, such as dimensional stability, by reducing the rate of water adsorption and evaporation, thus reducing the internal stresses of expanding and contracting.

A “treating agent” is a substance that, when combined with the cellulosic material, modifies the properties of the cellulosic material. In one instance, the treating agent comprises a polymer. The treating agent is applied to the cellulosic material through impregnation using pressure treatment. In one instance, the treating agent is applied to the cellulosic material as part of a dispersion. Once applied, the treating agent will permeate at least a portion of the pores of the cellulosic material.

As used herein, the term “polymer” refers to a molecule that is formed from one or more types of monomers. The polymer may be a polymer or a copolymer. As used herein, the term “copolymer” may refer to an alternating copolymer, a periodic copolymer, a statistical copolymer, a random copolymer, a block copolymer, a graft copolymer, or other copolymer as is known. As used herein, copolymer refers to a polymer formed by uniting two or more monomers. Examples of copolymers include bipolymers, terpolymers, tetrapolymers, and other higher-ordered copolymers. In one instance, the polymer comprises a sulfopolyester polymer. In one instance, the sulfopolyester polymer comprises, in polymerized form, a dicarboxylic acid, a polyhydroxy compound, and, a difunctional sulfomonomer. The difunctional sulfomonomer component of the sulfopolyester preferably comprises an aromatic nucleus having at least one sulfonate group and two functional groups, selected from the groups consisting of hydroxyl, carboxyl or amino functional groups. The amino functional group may be a primary amino group or a secondary amino group. Advantageous difunctional sulfomonomer components are those wherein the sulfonate salt group is attached to an aromatic acid nucleus such as benzene, naphthalene, diphenyl, oxydiphenyl, sulfonyldiphenyl or methylenediphenyl nucleus. Preferred results are obtained through the use of sulfophthalic acid, sulfoterephthalic acid, sulfoisophthalic acid, 4-sulfonaphthalene-2,7-dicarboxylic acid, and their esters. In one instance, the difunctional sulfomonomer component is selected from the group consisting of 5-(sodiosulfo)isophthalic acid, 5-(lithiosulfo)-isophthalic acid, and the methyl esters thereof. In one instance, the dicarboxylic acid comprises one or more of saturated aliphatic dicarboxylic acids or cycloaliphatic dicarboxylic acids. In one instance, the polyhydroxy compound comprises a diol, a triol, a tetrol or a combination thereof. In one instance, the difunctional sulfomonomer is present in an amount from 10 to 24 mole percent based on 100 mole percent dicarboxylic acid and 100 mole percent polyhydroxy compound.

In one instance, the polymer is a constituent part of an aqueous dispersion (referred to herein as an “aqueous dispersion” or as a “dispersion”). In one instance, the dispersion includes a surfactant. The aqueous dispersion is prepared such that the suspended particle size in the dispersion is suitable for penetrating the pores of the cellulosic material for distribution through the cellulosic material, for example having a particle size of 5-50,000 nm, more preferably 5-500 nm. In one instance, the dispersion also comprises one or more additives. In one instance, any solids present in the aqueous dispersion are held in a stable suspension and are transportable by the dispersion into the pores of the cellulosic material. A stable dispersion is a dispersion that, once formed, resists change in its properties over time and is therefore suitable for penetrating the pores of the cellulosic material. In one instance, the solid content of the dispersion is 1 to 75 weight percent.

In one instance the aqueous dispersion further comprises a solvent. In one instance the solvent is an organic solvent. In one instance the organic solvent is an oxygenated solvent, a hydrocarbon solvent, a halogenated solvent, or a combination thereof. In one instance, a surfactant is selected which reduces gelling of the polymer at the surface of the cellulosic material. In one instance, a surfactant is selected which increases the permeation of the polymer throughout the pores of the cellulosic material. For example, suitable surfactants may be nonionic, anionic, or cationic. Examples of nonionic surfactants include: alkoxylated alcohols, alkoxylated alkyl phenols, fatty acid esters, amine and amide derivatives, alkylpolyglucosides, ethylene oxide/propylene oxide copolymers, polyols and alkoxylated polyols. For example, a nonionic surfactant is TERGITOL™ L-62, commercially available from The Dow Chemical Company. Examples of anionic surfactants include: alkyl sulfates, alkyether sulfates, sulfated alkanolamides, alpha olefin sulfonates, lignosulfonates, sulfosuccinates, fatty acid salts, and phosphate esters. For example, an anionic surfactant is DOWFAX™ C10L, commercially available from The Dow Chemical Company. Examples of cationic surfactants include alkyltrimethylammonium salts.

The treating agent is combined with the cellulosic material. In one instance, the treating agent is introduced to the cellulosic material by pressure treatment, as described herein. The treating agent becomes impregnated in at least a portion of the pores of the cellulosic material, and thereby increases the weight of the cellulosic material. The treated cellulosic material has a weight gain of 15 to 80 percent (as calculated after drying the cellulosic material for at least 2 hours at or above 60° C.).

In one instance, the treating agent further comprises one or more additives. Additives which are known to add properties to treated cellulosic materials are suitable, such as, flame retardants, dispersants and/or dyes. For example, the additives may be organic compounds, metallic compounds, or organometallic compounds. In one instance, the additive is a material which improves the wetting or penetration of the polymer into the wood, for example, solvents or surfactants (anionic, cationic or nonionic) that are stable in the dispersion. Examples of additives include solvents, fillers, thickeners, emulsifiers, dispersing agents, buffers, pigments, penetrants, antistatic agents, odor substances, corrosion inhibitors, preservatives, siliconizing agents, rheology modifiers, anti-settling agents, anti-oxidants, other crosslinkers (e.g. diols and polyols), optical brighteners, waxes, coalescence agents, biocides and anti-foaming agents. Such waxes may include petroleum waxes, paraffin waxes, a natural wax, or a synthetic wax such as polyethylene wax or oxidized polyethylene wax, beeswax, or slack wax. In addition, the treating agent may be used in conjunction with wood preservatives containing, for example, cupric-ammonia, cupric-amine, cupric-ammonia-amine complexes, quaternary ammonium compounds, or other systems. For example, the treating agent may be used with Alkaline Copper-Quaternary ammonium (ACQ) preservative systems. The treating agent may also be used with wood preservative technologies which use zinc salts or boron containing compounds. Optionally, other additives such as insecticides, termiticides, fungicides, and moldicides may be included with the treating agent. In one instance, the additive is included as part of the dispersion and forms a stable suspension therewith.

In one instance, the cellulosic material is prepared as a treated cellulosic material by pressure treatment. The pressure used to pressure treat the cellulosic material may be either higher or lower than atmospheric pressure. In one instance, the pressure is lower than ambient pressure, for example, 0.0001 to 0.09 MPa (0.75 to 675 mmHg). In another instance, the pressure is greater than ambient pressure, for example, 0.1 to 1.7 MPa (750 to 12750 mmHg). It is envisioned that pressure treatment processes known in the art are suitable for impregnating the cellulosic material with the treating agent.

In one instance, the treated cellulosic material is prepared according to treatment protocol. In one instance, the treatment protocol comprises impregnating the cellulosic material with the treating agent. In one instance a method for preparing the treated cellulosic material includes one or more of the following steps: (a) depositing the cellulosic material in a vessel; (b) holding the vessel at vacuum for 5 to 60 minutes; (c) introducing the treating agent to the vessel; (d) pressurizing the vessel to 1.03 MPa for 5 to 60 minutes; (e) draining the excess treating agent; (f) optionally removing excess treating gent by vacuum and (g) drying the cellulosic material at 20 to 60° C. for 24 to 48 hours. In one instance, the method for preparing a treated cellulosic material comprises: (a) providing a cellulosic material; and (b) a treatment protocol comprising impregnating the cellulosic material with an aqueous dispersion comprising a polymer, the polymer comprising a sulfopolyester polymer.

The drying steps may be performed at a range of temperatures, whereby the duration of the drying step is proportional to the temperature. Suitable drying temperatures are between room temperature (roughly 20° C.) and 180° C. The drying may be performed in air, in nitrogen, or other suitable atmosphere.

A water immersion test is used to determine the water repellency of the treated cellulosic material according to the American Wood Protection Association Standard E4-11 procedure (Standard Method of Testing Water Repellency of Pressure Treated Wood). The water immersion test involves first, providing both a treated wafer, comprising a treated cellulosic material prepared as described herein, and a control wafer, comprising an untreated cellulosic material; second, measuring the tangential dimension of both the treated wafer and the control wafer to provide an initial tangential dimension (T₁) (where the tangential dimension is perpendicular to the direction of the grain of the cellulosic material); third, placing both the treated wafer and the control wafer in a conditioning chamber maintained at 65±3% relative humidity and 21±3° C. until a constant weight is achieved; fourth, immersing both the treated wafer and the control wafer in distilled water at 24±3° C. for 30 minutes; and fourth, measuring the tangential dimension of both the treated wafer and the control wafer following removal from the water to provide a post tangential dimension (T₂).

The percent swelling (S) for each individual wafer (both the treated wafer and the control wafer) is calculated as:

$$S ( \% ) = \frac{{T}_{2} - {T}_{1}}{{T}_{1}} \times 100$$

Preferably, the percent swelling of the treated cellulosic material is less than 2.5%, more preferably less than 2.0%.

Water-repellency efficiency (WRE) is used to determine the effectiveness of the treating agent in adding water repellant properties to the treated cellulosic material. WRE is calculated as:

$$WRE ( \% ) = \frac{{S}_{1} - {S}_{2}}{{S}_{1}} \times 100$$

S₁ refers to the percent swelling of the untreated wafer; S₂ refers to the percent swelling of the treated wafer. Preferably the WRE is at least 50%, more preferably at least 60%. The WRE of the control untreated wood is 0%.

The following Examples illustrate certain aspects of the present disclosure, but the scope of the present disclosure is not limited to the following Examples.

All the vacuum operations in the examples are in the range of −0.00399 MPa to −0.00267 MPa.

### Example 1

A polymer dispersion, Eastek 1000 polymer dispersion (available from the Eastman Chemical Company), having a glass transition temperature of 38° C., a solid concentration of 30 wt %, a pH of 6.0, a viscosity of 60 cp, and a particle diameter of 27 nm is provided.

### Example 2

A polymer dispersion, Eastek 1100 polymer dispersion (available from the Eastman Chemical Company), having a glass transition temperature of 55° C., and a calculated charge density of 0.66 meg/g, a solid concentration of 33 wt %, a pH of 6.2, a viscosity of 89 cp, and a particle diameter of 20 nm is provided.

### Example 3

A polymer dispersion is prepared using Eastman AQ14000 (available from the Eastman Chemical Company) as follows. A Helicone mixer is initially set to 90° C. and the bowl of the mixer is charged with 210 g of the AQ14000 polyester. This material is supplied as a brick, and small pieces are separated from the brick using a saw. The bowl is sealed, pressurized to 70 psi with nitrogen, and the heater set point is increased to 150° C. Once the measured temperature had reached 125° C. the mixer is turned on at max rpm and water is added to the bowl at 10 ml/min. A total of 810 ml of water is added to give a target % solids of 20%. Once all the water was added the mixing is stopped and the heater set point is dropped back down to 90° C. When the bowl temperature dropped below 95° C. the pressure on the bowl is released and dispersion is unloaded from the bowl. The aqueous dispersion has a solid concentration of 20 wt %, and an average particle diameter of 67 nm.

### Example 4

A total of 6 wt. percent DOWFAX™ C10L is added to the Eastek 1000 polymer dispersion (available from the Eastman Chemical Company), as described above.

Treatment Procedures.

The dispersions of Examples 1-4 are used to pressure-treat southern yellow pine blocks (having dimensions of 4 cm by 2 cm by 0.5 cm). Each block is pressed down by a ring in an evacuated Parr reactor for half an hour followed by drawing in 80 ml of the dispersion of the respective Example. The reactor is pressurized to 1.03 MPa under nitrogen and maintained for 60 min. The blocks are then placed in an oven with air drying at 60 C for 48 hours. For Example 4, one block is treated with the Eastek 1000 polymer containing 6 wt. percent DOWFAX™ C10L (Example 4A) and another block is treated with Eastek 1000 polymer without surfactant (Example 4B). It is observed that including a surfactant with the treating agent, as in Example 4A, provides an improved WRE and a reduced weight gain, as compared to not using the surfactant, as in Example 4B.

### Comparative Example

A southern yellow pine block (having dimensions of 4 cm by 2 cm by 0.5 cm) is dipped into the dispersion described in Example 1 for 2 minutes to provide a uniform coating to the block, thereby providing a surface treatment thereto. The block is air dried overnight. The results are provided in Table 1.

TABLE 1

| Treatment | WRE | Percent Swelling (S) | Weight gain |
|---|---|---|---|
| Example 1 | 70% | 1.3% | 43.2% |
| Example 2 | 81% | 0.8% | 36.7% |
| Example 3 | 78% | 1.0% | 25.7% |
| Example 4A | 66% | 1.5% | 35.1% |
| Example 4B | 60% | 1.8% | 39.0% |
| Comparative | 17% | 2.7% | 14.8% |

1. A treated cellulosic material comprising:
a cellulosic material having a porous structure defining a plurality of pores, at least a portion of the pores containing a treating agent comprising a polymer, the polymer comprising a sulfopolyester polymer.

2. The treated cellulosic material of claim 1, wherein the sulfopolyester polymer comprises, in polymerized form, a dicarboxylic acid, a polyhydroxy compound, and, a difunctional sulfomonomer.

3. The treated cellulosic material of claim 2, wherein the difunctional sulfomonomer comprises at least one sulfonate group attached to an aromatic nucleus having two functional groups.

4. The treated cellulosic material of claim 3, wherein each of the two functional groups are selected from the list consisting of hydroxyl, carboxyl or amino functional groups.

5. The treated cellulosic material of any one of claims 3-4, wherein the difunctional sulfomonomer is selected from the group consisting of 5-(sodiosulfo)isophthalic acid, 5-(lithiosulfo)-isophthalic acid, and the methyl esters thereof or a mixture thereof.

6. The treated cellulosic material of claim 2, wherein the dicarboxylic acid comprises one or more of aromatic, saturated aliphatic dicarboxylic acids, or cycloaliphatic dicarboxylic acids.

7. The treated cellulosic material of claim 2, wherein the polyhydroxy compound comprises a diol, a triol, a tetrol or a combination thereof.

8. The treated cellulosic material of any one of claims 1-7, wherein the treated cellulosic material is prepared by impregnating the cellulosic material with an aqueous dispersion comprising the treating agent.

9. The treated cellulosic material of any one of claims 1-8, further comprising one or more additives.

10. The treated cellulosic material of any one of claims 1-9, further comprising a surfactant.

11. A method for preparing a treated cellulosic material comprising:
(a) providing a cellulosic material; and
(b) a treatment protocol comprising impregnating the cellulosic material with an aqueous dispersion comprising a polymer, the polymer comprising a sulfopolyester polymer.

12. The method of claim 11, wherein the treatment protocol is conducted under pressure greater than or lower than ambient.

13. The method of claim 11, wherein the polymer comprises, in polyermized form, a dicarboxylic acid, a polyhydroxy compound, and a difunctional sulfomonomer.

14. The method of claim 13, wherein the difunctional sulfomonomer is selected from the group consisting of 5-(sodiosulfo)isophthalic acid, 5-(lithiosulfo)-isophthalic acid, and the methyl esters thereof, or a mixture thereof.
